(19) United States
(12) Patent Application Publication
(10) Pub. No.: US 2025/0289225 A1
(43) Pub. Date: Sep. 18, 2025

(54) NOZZLE PLATE MANUFACTURING METHOD, NOZZLE PLATE, AND FLUID EJECTION HEAD

(71) Applicant: KONICA MINOLTA, INC., Tokyo (JP)

(72) Inventors: Hiroshi KAJITA, Osaka-shi, Osaka (JP); Kouichi SAMESHIMA, Kyoto-shi, Kyoto (JP)

(21) Appl. No.: 18/283,276

(22) PCT Filed: Mar. 31, 2021
(86) PCT No.: PCT/JP2021/013756

§ 371 Date: Jul. 16, 2024

(51) Int. Cl. B41J 2/16; B41J 2/14

(52) U.S. Cl. CPC B41J 2/1628; B41J 2/14233; B41J 2/1606; B41J 2/1629; B41J 2/1631; B41J 2/1642; B41J 2/1645

(57) ABSTRACT

The present invention produces, through steps 1-5 described below, a nozzle plate having a nozzle hole that has formed therein at least a tapered nozzle portion 12 and a straight communication channel 13. Step 1 (S-1): a step for preparing a mono-crystalline silicon substrate 1 in which the surface crystal orientation is a (100) plane. Step 2 (S-2): a step for uniformly forming a mask layer 2 on the surface of the mono-crystalline silicon substrate. Step (S-3): a step for forming an opening pattern 3 in the mask layer. Step 4 (S-4): a step for forming a through hole 4 by performing penetration machining on the mono-crystalline silicon substrate, which is located under the opening pattern, through dry etching from the surface of the substrate. Step 5 (S-5): a step for forming a tapered nozzle portion and a straight communication channel which is contiguous to said tapered nozzle portion, by expanding the through hole through anisotropic wet etching on the mono-crystalline silicon substrate.

### FIELD OF TECHNOLOGY

The present invention relates to a nozzle plate manufacturing method, a nozzle plate, and a fluid ejection head.

### BACKGROUND TECHNOLOGY

Conventionally, a method for manufacturing a nozzle plate having a nozzle tapered portion and a straight communication passage in a nozzle hole has been proposed. A method for manufacturing such a nozzle plate is disclosed, for example, in Patent Literature 1 and Patent Literature 2.

Patent Literature 1 discloses a method for manufacturing a funnel-shaped nozzle plate in which a nozzle tapered portion and a nozzle straight portion are formed on an SOI (silicon on insulator) substrate, which is a silicon wafer having a structure in which a silicon single crystal layer is formed on an oxide film.

In Patent Literature 1, for the previous hole formed by wet etching, a photoresist is patterned from the opposite side to etch the later hole. That is, this is a method of making a hole drilled from one surface of the substrate and a hole drilled from the other surface meet inside the substrate to communicate with each other.

Patent Literature 2 is also the same method because wet etching is performed from above and below without penetrating holes from one side.

### CITATION LIST

### Patent Literature

Patent Literature 1: JP 5519263 B2

Patent Literature 2: JP 2014-512989 A

### SUMMARY OF THE INVENTION

### Technical Problem

In the related art described above, a nozzle hole is formed by making a hole drilled from one surface of the substrate and a hole drilled from the other surface meet inside the substrate to communicate with each other. However, positional deviation between the hole drilled from one surface and the hole drilled from the other surface is inevitable.

Therefore, according to the conventional manufacturing method described above, due to positional deviation between the nozzle tapered portion and the straight communication passage, the flow of the fluid may lose symmetry and the ejection angle may deteriorate. In addition, due to the positional deviation, stagnation may occur in the nozzle and air bubbles may accumulate there. This may deteriorate the ability to remove bubbles.

The present invention has been made in view of the aforementioned problems, and it is an object of the present invention to provide a nozzle plate, in which a nozzle tapered portion and a straight communication passage are continuous without positional deviation, and a fluid ejection head including the nozzle plate.

### Solution to Problem

One aspect of the present invention to solve the aforementioned problems is a method for manufacturing a nozzle plate for a fluid ejection head. This is a nozzle plate manufacturing method for manufacturing, through following steps 1 to 5, a nozzle plate having at least a nozzle tapered portion and a straight communication passage in a nozzle hole.

step 1: a step of preparing a single crystal silicon substrate whose surface has a crystal orientation of a [100] plane,

step 2: a step of uniformly forming a mask layer on the surface of the single crystal silicon substrate,

step 3: a step of forming an opening pattern in the mask layer,

step 4: a step of forming a through hole by penetrating the single crystal silicon substrate located below the opening pattern from the surface by dry etching,

step 5: a step of forming a nozzle tapered portion and a straight communication passage continuous with the nozzle tapered portion by enlarging the through hole by anisotropic wet etching on the single crystal silicon substrate.

Another aspect of the present invention is a nozzle plate for a fluid ejection head including a straight communication passage formed by four [100] planes continuous in a direction in which a diameter of a nozzle tapered portion, which is formed by four [111] planes of single crystal silicon, increases.

### Advantageous Effects of Invention

According to the method for manufacturing a nozzle plate for a fluid ejection head according to one aspect of the present invention described above, the nozzle tapered portion and the straight communication passage are formed for each nozzle by enlarging the through hole, which is formed so as to penetrate from one opening pattern. Therefore, it is possible to form a nozzle plate in which a nozzle tapered portion and a straight communication passage are continuous without positional deviation.

According to the nozzle plate according to one aspect of the present invention described above, since the nozzle tapered portion and the straight communication passage are continuous without positional deviation, the symmetry of the flow of the fluid is maintained and the ejection angle is stabilized. In addition, since stagnation is less likely to occur in the nozzle, the ability to remove bubbles is also good.

### BRIEF DESCRIPTION OF DRAWINGS

FIG. 1 is a cross-sectional view showing main steps of a nozzle plate manufacturing method according to a first embodiment of the present invention.

FIG. 2 is a back view of a nozzle plate according to the first embodiment of the present invention and shows a nozzle hole.

FIG. 3 is a cross-sectional view of the nozzle plate according to the first embodiment of the present invention and shows the one with a protective film.

FIG. 4 is a cross-sectional view showing main steps of a nozzle plate manufacturing method according to a second embodiment of the present invention.

FIG. 5 is a cross-sectional view of a nozzle plate according to the second embodiment of the present invention and shows the one with a protective film.

FIG. 6 is a back view of each nozzle plate according to the first and second embodiments of the present invention and shows a nozzle hole and its surrounding area.

FIG. 7 shows an A2-A2 cross section in FIG. 6 (in the case of the second embodiment).

FIG. 8 is a cross-sectional view showing an example of the configuration of a fluid ejection head (inkjet head).

FIG. 9 is a cross-sectional view showing main steps of a nozzle plate manufacturing method according to Example 1 of the present invention.

FIG. 10 is a cross-sectional view showing main steps of a nozzle plate manufacturing method according to Comparative example 1.

### DETAILED DESCRIPTION

### First Embodiment

First, a nozzle plate manufacturing method according to a first embodiment of the present invention and a nozzle plate manufactured by the nozzle plate manufacturing method will be described.

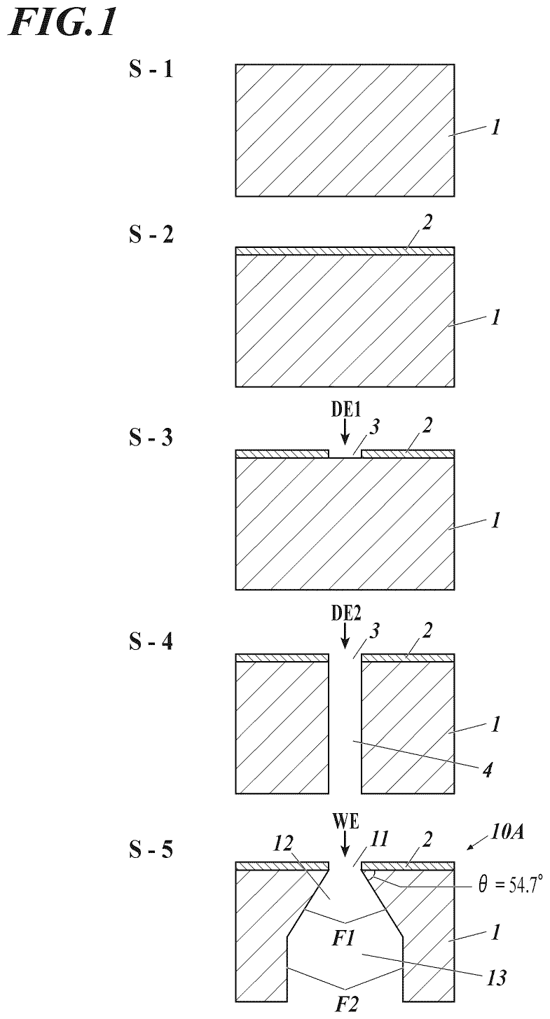

The nozzle plate manufacturing method according to the present invention is a method for manufacturing a nozzle plate for a fluid ejection head and is a nozzle plate manufacturing method for manufacturing a nozzle plate having at least a nozzle tapered portion and a straight communication passage in a nozzle hole through the following steps 1 to 5. FIG. 1 shows a reference diagram for step 1 (S-1) to step 5 (S-5).

First, in step 1 (S-1 in FIG. 1), a single crystal silicon substrate 1 whose surface has a crystal orientation of a [100] plane is prepared. The single crystal silicon substrate 1 whose surface is the [100] plane is a plate-shaped member formed of silicon and having a thickness of about 100 to 725 μm. By using the single crystal silicon substrate 1 as a base material of a nozzle substrate, the nozzle plate can be processed with high accuracy. Therefore, it is possible to form a nozzle plate with little positional error or shape variation.

Then, as step 2 (S-2 in FIG. 1), a mask layer 2 is uniformly formed on the surface of the single crystal silicon substrate 1.

A material for forming the mask layer 2 is not particularly limited, but for example, SiO₂ (silicon oxide), SiN (silicon nitride), Al (aluminum), Cr (chromium), and the like can be used.

As a method for forming a mask layer, for example, a thermal oxidation method or a CVD method (chemical vaper deposition, chemical vapor deposition, chemical vapor deposition method) can be applied for the formation of a mask layer formed of SiO₂. For the formation of a mask layer formed of SiN, a CVD method or an LPCVD method (low pressure CVD method, low pressure vapor deposition method) can be applied. SiO₂ using a thermal oxidation method is preferred. SiO₂ has good adhesion to Si and is effective in preventing side etching during anisotropic wet etching.

The mask layer 2 may be a single layer as shown in FIG. 1, or may have a two-layer structure. The mask layer 2 may also be formed on the back surface side of the silicon substrate 1 in this step.

Then, as step 3 (S-3 in FIG. 1), a circular or polygonal opening pattern 3 is formed in the mask layer 2.

Specifically, a resist pattern is formed on the mask layer 2 by using a known photolithography technique, and the mask layer 2 is dry-etched (DE1) by using the resist pattern as a mask to form the opening pattern 3.

A positive photoresist or a negative photoresist can be used to form a resist layer. Known materials can be used as a positive photoresist and a negative photoresist. For example, as a negative photoresist, ZPN-1150-90 manufactured by Zeon Corporation can be used. As a positive photoresist, OFPR-800 LB and OEBR-CAP112PM manufactured by TOKYO OHKA KOGYO CO., LTD. can be used.

The resist layer is formed in a predetermined thickness by coating using a spin coater or the like. Thereafter, pre-baking processing is performed under conditions such as 110° C. and 90 seconds.

In order to improve adhesion, HMDS (hexamethyldisilazane) treatment may be performed before resist coating. For the HMDS treatment, an organic material called hexamethyldisilazane, for example, OAP (hexamethyldisilazane) manufactured by TOKYO OHKA KOGYO CO., LTD. can be used. Similarly, to the resist coating, the coating may be performed using a spin coater, or the effect of improving adhesion can be expected by exposing to hexamethyldisilazane vapor.

By using a predetermined mask, the resist layer is exposed with an aligner or the like. For example, in the case of a contact aligner, the amount of light of about 50 mJ/cm² is done. Thereafter, a resist pattern is formed on the mask layer 2 by immersing the resist layer in a developer (for example, NMD-3 manufactured by TOKYO OHKA KOGYO CO., LTD.) for 60 to 90 seconds to remove the exposed portion of the resist layer.

The opening pattern 3 is formed by dry-etching (DE1) the mask layer 2 with the resist pattern as a mask. Thereafter, the resist pattern is removed.

At this time, the dry etching (DE1) can be performed using a dry etching apparatus such as an RIE (reactive ion etching) apparatus or an ICP (inductively coupled plasma)-RIE etching apparatus, which is a dry etching apparatus adopting an inductive coupling method as a discharge method. As a process gas, CHF₃, CF₄, and the like can be used.

As an example, the opening pattern 3 can be formed by performing etching for a predetermined time under conditions of a CHF₃ gas flow rate of 80 sccm, a pressure of 3 Pa, and an RF power of 90 W using a dry etching apparatus RIE-100C manufactured by Samco Inc.

The resist pattern can be removed by, for example, a wet process using acetone or an alkaline solution or a dry process using oxygen plasma.

Then, in step 4 (S-4 in FIG. 1), the single crystal silicon substrate 1 located below the opening pattern 3 is through-processed by dry etching (DE2) from the surface to form a through hole 4.

At this time, the dry etching (DE2) can be performed using an ICP-RIE etching apparatus adopting inductively coupled plasma for a discharge method.

By using the Bosch process, in which film formation and etching are cyclically repeated using SF₆, C₄F₈, O₂, and the like as a process gas, it is possible to form the vertical through hole 4 with high accuracy.

Then, in step 5 (S-5 in FIG. 1), the through hole 4 is enlarged by performing anisotropic wet etching (WE) on the single crystal silicon substrate 1, thereby forming a nozzle tapered portion 12 and a straight communication passage 13 continuous with the nozzle tapered portion 12.

For the anisotropic wet etching (WE) in step 5, an alkaline aqueous solution, such as KOH, TMAH (tetramethylammonium hydroxide), or EDP (ethylenediaminepyrocatechol), is used. The nozzle tapered portion 12 is the [111] plane of the Si single crystal. Since the [111] plane has an extremely slow etching rate, the taper is formed at an angle θ of 54.7° as shown in the diagram.

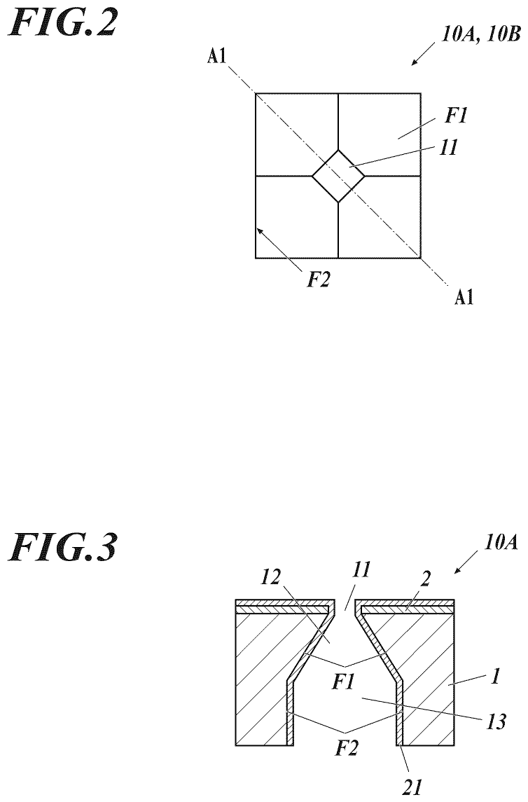

For example, by performing wet etching at 70° C. using a 40 mass % aqueous solution of KOH, the nozzle tapered portion 12 and the straight communication passage 13 can be formed as shown in S-5 of FIG. 1 and the back view of FIG. 2.

The nozzle tapered portion 12 has a nozzle tip ejection port 11 as a small diameter end. The straight communication passage 13 is continuous with the large diameter end of the nozzle tapered portion 12.

The inner surface F1 of the nozzle tapered portion 12 has four planes. The four planes F1 are [111] planes.

An angle θ between the surface of the silicon substrate 1 where the nozzle tip ejection port 11 is open and the surface F1 is 54.7°.

The inner surface F2 of the straight communication passage 13 also has four planes. The four planes F2 are [100] planes.

Therefore, a nozzle plate 10A manufactured as described above has the straight communication passage 13 formed by the four [100] planes continuous in a direction in which the diameter of the nozzle tapered portion 12, which is formed by the four planes of single crystal silicon, increases.

According to the nozzle plate manufacturing method according to the first embodiment of the present invention described above, the nozzle tapered portion 12 and the straight communication passage 13 are formed for each nozzle by enlarging the through hole 4, which is formed so as to penetrate from one opening pattern 3. Therefore, it is possible to form the nozzle plate 10A having a nozzle hole in which the nozzle tapered portion 12 and the straight communication passage 13 are continuous without positional deviation.

According to the nozzle plate 10A according to the first embodiment of the present invention, since the nozzle tapered portion 12 and the straight communication passage 13 communicate with each other without positional deviation, the symmetry of the flow of the fluid is maintained and the ejection angle is stabilized. In addition, since stagnation is less likely to occur in the nozzle, the ability to remove bubbles is also good.

For long-term use for fluid ejection, a protective film 21 may be formed in the nozzle plate 10A as shown in FIG. 3. In this case, after step 5 (S-5), a step of forming the protective film 21 that covers a surface including the inside of the nozzle tapered portion 12 and the inside of the straight communication passage 13 is performed.

The protective film 21 is formed of a material that does not dissolve upon contact with the ejection fluid (ink or the like). For example, a metal oxide film (tantalum pentoxide, hafnium oxide, niobium oxide, titanium oxide, zirconium oxide, and the like), a metal silicate film (tantalum silicate, hafnium silicate, niobium silicate, titanium silicate, zirconium silicate, and the like) obtained by making the metal oxide film contain silicon, or a material used to form the mask layer can be selectively used. As the protective film 21, an organic film using polyimide, polyamide, parylene, and the like may be used. The thickness of the protective film 21 is not particularly limited, but can be, for example, 0.05 to 20 μm.

### Second Embodiment

Next, a nozzle plate manufacturing method according to a second embodiment of the present invention and a nozzle plate manufactured by the nozzle plate manufacturing method will be described.

The nozzle plate manufacturing method according to the second embodiment of the present invention is a method in which a nozzle straight portion 14 having a nozzle tip ejection port 11 as one end is provided by performing the following steps 6 and 7 between the steps 3 and 4 in the first embodiment.

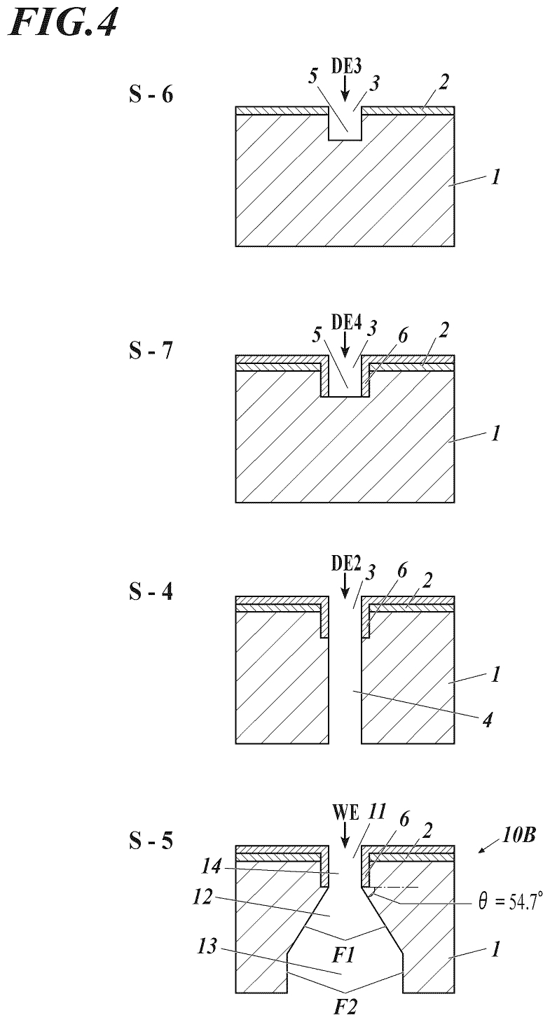

FIG. 4 shows a reference diagram of step 6 (S-6), step 7 (S-7), and step 4 (S-4) and step 5 (S-5) after step 7.

Steps 1 to 3 are performed in the same manner as in the first embodiment described above.

Then, in step 6 (S-6 in FIG. 4), the single crystal silicon substrate 1 located below the opening pattern 3 is deeply etched from the surface by dry etching (DE3), thereby forming a hole 5.

The dry etching (DE3) in this step can be performed by using the same method as the dry etching (DE2) in step 4. However, after drilling by the target length of the nozzle straight portion 14, the etching is finished so that the penetration is not performed any more.

Then, in step 7 (S-7 in FIG. 4), a mask layer 6 is formed on the side wall of the hole 5.

The mask layer 6 in this step can be formed by using the same material and method as for the mask layer 2 in step 2. A mask layer on the bottom of the hole 5 is removed by resist patterning and dry etching (DE4) as in step 3.

The mask layers 2 and 6 in steps 2 and 7 may be formed on both the top and bottom surfaces of the silicon substrate 1 by thermal oxidation or the like. However, when forming the mask layers 2 and 6 on both the surfaces, it is necessary to remove a mask layer on the bottom of the through hole 4 at least before step 5. This is because, if the mask layer on the bottom of the through hole 4 remains, the etching solution stays inside the through hole 4 in anisotropic wet etching in the subsequent step 5 and H₂ gas generated by the reaction between the alkaline wet etching solution and Si also stays, and accordingly, the progress of the etching is delayed, and shape variation occurs.

Thereafter, step 4 (S-4 in FIG. 4) and then step 5 (S-5 in FIG. 4) are performed in the same manner as in the first embodiment described above. In step 4 (S-4 in FIG. 4), the bottom of the hole 5 is drilled to form the through hole 4. In step 5 (S-5 in FIG. 4), a portion of the through hole 4 where the Si below the mask layer 6 is exposed is enlarged to form the nozzle tapered portion 12 communicating with the nozzle straight portion 14 and the straight communication passage 13.

According to the manufacturing method of the second embodiment described above, it is possible to manufacture a nozzle plate 10B having the nozzle straight portion 14 with a desired length at the nozzle tip.

The nozzle straight portion 14 has one end as the nozzle tip ejection port 11 and the other end as the small diameter end of the nozzle tapered portion 12.

In the nozzle plate 10B, similarly to the nozzle plate 10A in the first embodiment described above, the taper angle θ is 54.7°, the four inner surfaces F1 of the nozzle tapered portion 12 are [111] planes, and the four inner surfaces F2 of the straight communication passage 13 are [100] planes.

According to the nozzle plate manufacturing method according to the second embodiment of the present invention described above, as in the first embodiment described above, the nozzle tapered portion 12 and the straight communication passage 13 are formed for each nozzle by enlarging the through hole 4, which is formed so as to penetrate from one opening pattern 3. Therefore, it is possible to form the nozzle plate 10B having a nozzle hole in which the nozzle tapered portion 12 and the straight communication passage 13 are continuous without positional deviation.

According to the nozzle plate manufacturing method according to the second embodiment of the present invention, the side wall of the hole 5 is protected by the mask layer 6. Therefore, since the side wall of the hole 5 is not eroded by the anisotropic wet etching (WE) in step 5 (S-5 in FIG. 4), the nozzle straight portion 14 can be formed. As a result, the nozzle straight portion 14 and the nozzle tapered portion 12 can be continuous without positional deviation.

According to the nozzle plate 10B according to the second embodiment of the present invention, as in the first embodiment described above, the nozzle tapered portion 12 and the straight communication passage 13 are continuous without positional deviation, and the nozzle straight portion 14 and the nozzle tapered portion 12 is also continuous without positional deviation. Therefore, the symmetry of the flow of the fluid is maintained and the ejection angle is stabilized. In addition, since stagnation is less likely to occur in the nozzle, the ability to remove bubbles is also good.

According to the nozzle plate 10A according to the second embodiment of the present invention, since the nozzle straight portion 14 is continuous with the nozzle tapered portion 12 without positional deviation, the ejection angle is further stabilized.

As in the first embodiment, a protective film 22 may be formed in the nozzle plate 10B as shown in FIG. 5. In this case, after step 5 (S-5), a step of forming the protective film 22 that covers a surface including the inside of the nozzle straight portion 14, the inside of the nozzle tapered portion 12, and the inside of the straight communication passage 13 is performed.

The shape of the nozzle tip ejection port 11 in step 3 in the first and second embodiments described above does not matter as long as ejection is possible even with a circular or polygonal pattern. This is because any shape does not affect the connection between the nozzle tapered portion 12 and the straight communication passage 13.

After step 5 in the first and second embodiments described above, the mask layer 2 may or may not be removed. This is because there is no effect on the connection between the nozzle tapered portion 12 and the straight communication passage 13.

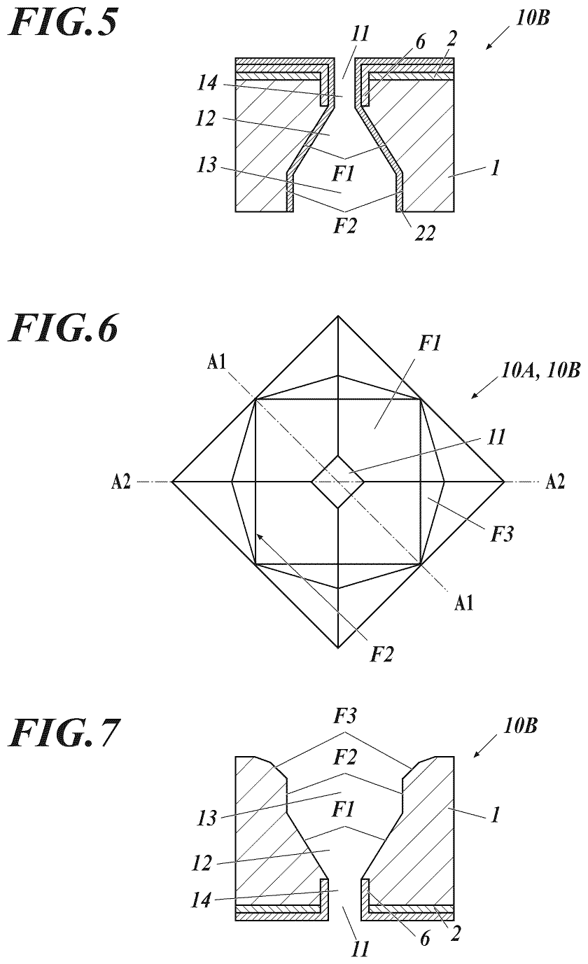

After step 5 in the first and second embodiments described above, a crystal plane F3 shown in FIG. 6 and FIG. 7 appears on the back surface side of the single crystal silicon substrate 1, but there is no effect on the connection between the nozzle tapered portion 12 and the straight communication passage 13. For this reason, there is no problem even if the mask layer 2 is used as it is. However, there is no problem even if the nozzle plate is made thin by grinding or the like from the back surface to eliminate a portion of the crystal plane F3. FIG. 7 corresponds to A2-A2 in FIG. 6 and shows the case of the second embodiment. The cross-section views of FIG. 1 and FIG. 4 correspond to the A1-A1 cross section shown in FIG. 2 and FIG. 6.

### Fluid Ejection Head

Each of the nozzle plates (10A and 10B) described above is applied as a nozzle plate (110) of a fluid ejection head (101) disclosed below. As a configuration example of the fluid ejection head, a configuration example of an inkjet head is disclosed below.

### Configuration Example of Inkjet Head

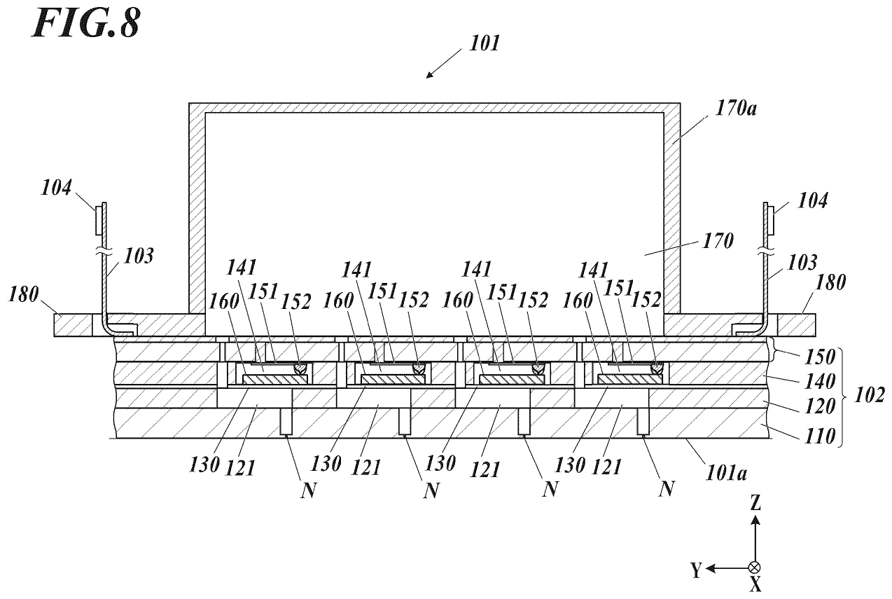

FIG. 8 is a cross-sectional view of the inkjet head (101) when viewed from the side (−X direction side). FIG. 8 shows a cross section of the inkjet head (101) in a plane including four nozzles (N) included in four nozzle rows.

The inkjet head (101) includes a head chip (102), a common ink chamber (170), a support substrate (180), a wiring member (103), a driver (104), and the like.

The head chip (102) is a structure for ejecting ink from the nozzles (N) and is formed by stacking a plurality of (four in FIG. 8) plate-shaped substrates. The lowest substrate in the head chip (102) is the nozzle plate (110, nozzle forming member). A plurality of nozzles (N) each having a structure according to the present invention are provided in the nozzle plate (110), so that ink can be ejected approximately perpendicularly to the exposed surface (ink ejection surface (101a)) of the nozzle plate (110) through the openings (corresponding to the “nozzle tip ejection port 11” described above) of the nozzles (N). On a side of the nozzle plate (110) opposite to the ink ejection surface (101a), a pressure chamber substrate (120, chamber plate), a spacer substrate (140), and a wiring substrate (150) are bonded and stacked in order upward (in the Z direction in FIG. 8). Hereinafter, the nozzle plate (110), the pressure chamber substrate (120), the spacer substrate (140), and the wiring substrate (150) are also referred to as stacked substrates (110, 120, 140, 150).

Ink channels communicating with the nozzles (N) are provided in the stacked substrates (110, 120, 140, 150), and are open on the surface of the wiring substrate (150) on the exposed side (+Z direction side). On the exposed surface of the wiring substrate (150), the common ink chamber (170) is provided so as to cover all openings. Ink stored in an ink chamber forming member (not shown) of the common ink chamber (170) is supplied to each nozzle (N) through the opening of the wiring substrate (150).

In the nozzle plate (110) described in FIG. 8, detailed descriptions of a nozzle tapered portion and a straight communication passage in the nozzle (N) are omitted.

A pressure chamber (121, ink reservoir) is provided in the middle of the ink channel. The pressure chamber (121) is provided so as to penetrate the pressure chamber substrate (120) in the vertical direction (Z direction). The upper surface of the pressure chamber (121) is formed by a vibration plate (130) provided between the pressure chamber substrate (120) and the spacer substrate (140). A pressure change is given to the ink in the pressure chamber (121) due to deformation of the vibration plate (130) and the pressure chamber (121) that is caused by displacement (deformation) of a piezoelectric element (160) in a storage (141) provided adjacent to the pressure chamber (121) with the vibration plate (130) interposed therebetween. By giving an appropriate pressure change to the ink in the pressure chamber (121), the ink in the ink channel is ejected as droplets from the nozzle (N) communicating with the pressure chamber (121).

The support substrate (180) is bonded to the upper surface of the head chip (102) and holds an ink chamber forming member (not shown) of the common ink chamber (170). An opening having approximately the same size and shape as an opening in the lower surface of the ink chamber forming member (not shown) is provided in the support substrate (180). The ink in the common ink chamber (170) is supplied to the top surface of the head chip (102) through the opening in the lower surface of the ink chamber forming member and the opening in the support substrate (180).

The wiring member (103) is, for example, FPC (flexible printed circuits) or the like, and is connected to the wiring of the wiring substrate (150). The piezoelectric element (160) is displaced by a driving signal that is transmitted to a wiring (151) and a connector (152, conductive member) in the storage (141) through the wiring. The wiring member (103) is pulled out through the support substrate (180) and connected to the driver (104).

The driver (104) receives a control signal from a controller of an inkjet recording apparatus, power supply from a power supplier, and the like, and outputs an appropriate driving signal for the piezoelectric element (160) to the wiring member (103) according to an ink ejection operation or non-ejection operation from each nozzle N. The driver (104) is formed by an IC (integrated circuit) or the like.

According to the fluid ejection head described above, there are provided the nozzle plates 10A and 10B each having a nozzle hole in which the nozzle tapered portion 12 and the straight communication passage 13 are continuous without positional deviation. Therefore, the symmetry of the flow of the fluid (ink or the like) is maintained and the ejection angle is stabilized. In addition, since stagnation is less likely to occur in the nozzle, the ability to remove bubbles is also good. Since the ejection angle is stable and ejection failure is less likely to occur, the image quality of the inkjet recording apparatus can be improved.

### EXAMPLES

Examples of the present invention and comparative examples are disclosed below.

### Example 1

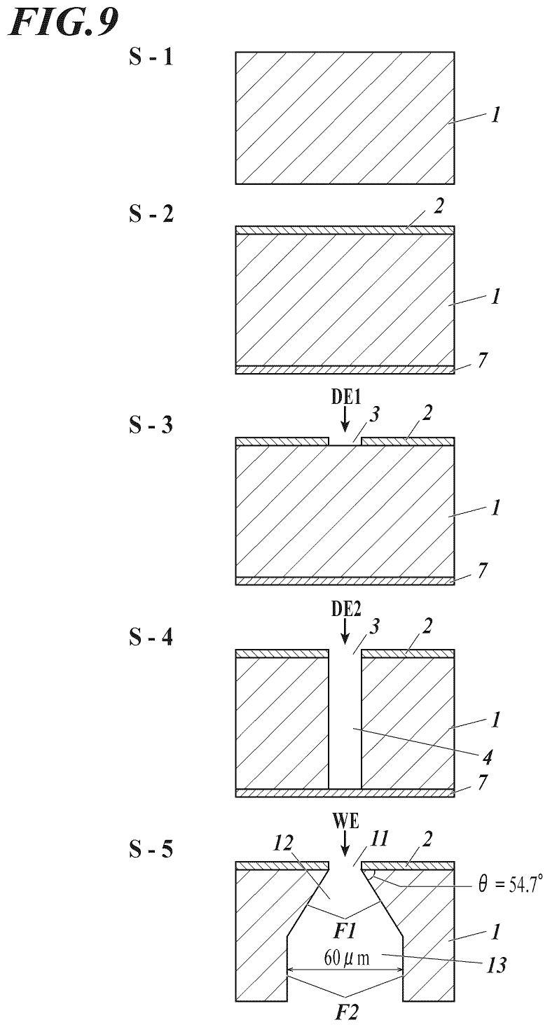

Example 1 is an example according to the first embodiment described above. FIG. 9 shows a reference diagram.

In step 1 (S-1 in FIG. 9), a single crystal silicon wafer (1) having a crystal orientation of a plane and a thickness of 200 μm was prepared.

In step 2 (S-2 in FIG. 9), an oxide film with a thickness of 2 μm was formed as the mask layer 2 on the single crystal silicon wafer (1) by using a thermal oxidation method.

In step 3 (S-3 in FIG. 9), a square opening pattern with one side of 20 μm was formed on the oxide film (2) by using a positive photoresist. Thereafter, etching was performed with CHF₃ gas by using an RIE (reactive ion etching) apparatus to form a square opening pattern 3 with one side of 20 μm in the oxide film (2) in accordance with the resist opening pattern. Thereafter, the photoresist was removed by being immersed in acetone.

In step 4 (S-4 in FIG. 9), etching was performed by the Bosch process using SF6 and C4F8 gases and an Si deep etching apparatus to form the through hole 4 with a diameter of 20 μm in the single crystal silicon wafer (1) with a thickness of 200 μm.

In step 5 (S-5 in FIG. 9), an oxide film 7 on the back surface of the single crystal silicon wafer (1) was removed by the RIE apparatus, and etching was performed until the width of the straight communication passage 13 became 60 μm by immersing in a 40 wt % KOH aqueous solution at 80° C., thereby forming the nozzle tapered portion 12 and the straight communication passage 13.

Thereafter, ten nozzle plates (10A) were obtained from the single crystal silicon wafer (1) by using a dicing saw, and each nozzle plate was manufactured so as to have 2000 nozzle holes.

As a result of manufacturing ten inkjet heads (101) using the nozzle plate and measuring the droplet angles of 10 heads×2000 nozzles at a droplet speed of 6 m/s with an ejection inspection machine, the droplet angles were in the range of −0.2° to 0.2°, and there was no problem with the ejection angle.

### Comparative Example 1

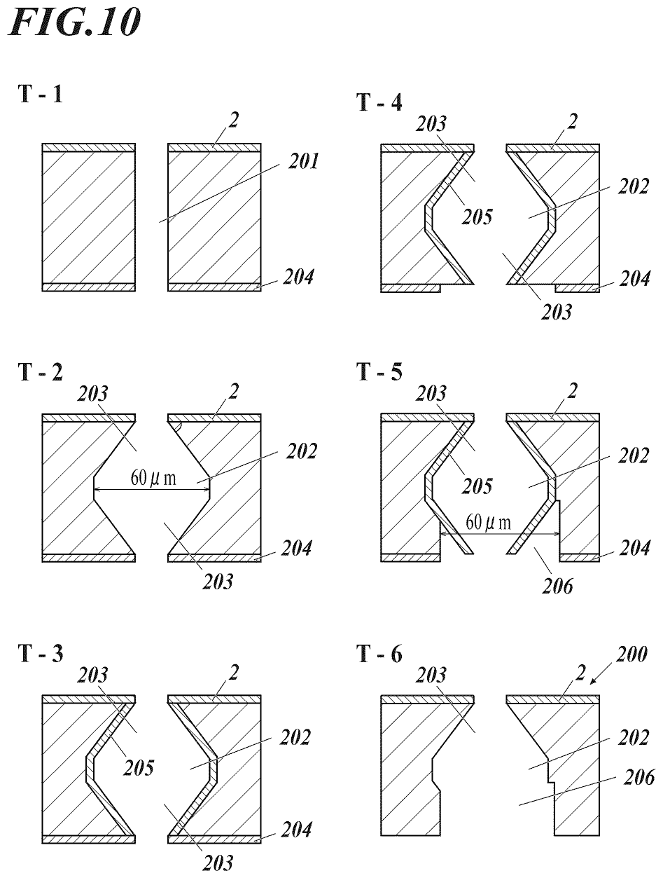

After steps 1 to 4 similar to those in Example 1, the following steps were performed to manufacture a nozzle plate of Comparative example 1. An oxide film on the bottom of a through hole 201 was removed (T-1 in FIG. 10), and etching was performed by immersing in a 40 wt % KOH aqueous solution at 80° C. to process the straight communication passage 202 up to the diameter of 60 μm (T-2 in FIG. 10). Thereafter, an oxide film 205 was formed on the inner walls of the communication passages 202 and 203 by thermal oxidation (T-3 in FIG. 10). An oxide film 204 on the back surface was removed to form an opening with a diameter of 60 μm by using an RIE apparatus (T-4 in FIG. 10). By dry etching, a straight communication passage 206 was processed from the back surface to the straight communication passage 202 (T-5 in FIG. 10). The oxide film 205 was removed by using hydrofluoric acid (T-6 in FIG. 10).

As a result, a nozzle plate 200 of Comparative example 1 was obtained. Thereafter, as a result of manufacturing ten inkjet heads and measuring the droplet angles of 10 heads×2000nozzles at a droplet speed of 6 m/s in the same manner as in Example 1, the droplet angles were in the range of −1.0° to 1.2°, and the ejection angle was worse than in Example 1.

### Example 2

Example 2 is an example according to the second embodiment.

In step 6 (S-6 in FIG. 4), after step 3 (S-3 in FIG. 1), etching was performed by the Bosch process using SF₆ and C₄F₈ gases and an Si deep etching apparatus to form the hole 5 with a depth of 20 μm.

In step 7 (S-7 in FIG. 4), an oxide film (6) of 0.5 μm was formed on the wafer (1) by thermal oxidation. Thereafter, an oxide film on the bottom surface of the hole 5 having a depth of 20 μm was removed by using an RIE apparatus. At this time, the oxide film on the bottom surface of the hole 5 is etched earlier than the oxide film on the side wall of the hole 5. Therefore, only the oxide film on the side wall of the hole 5 remains.

Thereafter, as a result of manufacturing ten inkjet heads by applying the nozzle plate (10B) manufactured through steps 4 and 5 and similarly measuring the droplet angles of 10heads×2000 nozzles at a droplet speed of 6 m/s, the droplet angles were in the range of −0.2° to 0.2°, and there was no problem with the ejection angle.

### Protective Film Durability Test

For ten nozzle plates manufactured in the same manner as in Example 1 and Comparative example 1, Ta₂O₅ serving as a protective film against ink was formed by using a CVD method.

These nozzle plates were immersed in an alkaline printing ink and subjected to an acceleration test at 60° C. for eight weeks (corresponding to about two years at 25° C.). As a result, there was no problem with the nozzle plates in Example 1. However, in the eight nozzle plates in Comparative example 1, erosion of Si was confirmed at the joint between the straight communication passage 202 and the straight communication passage 206.

While the embodiments of the present invention have been described above, the embodiments are shown as examples and can be implemented in various other forms, and the components can be omitted, replaced, or changed without departing from the scope of the invention.

### INDUSTRIAL APPLICABILITY

The present invention can be used for a nozzle plate manufacturing method, a nozzle plate, and a fluid ejection head.

### REFERENCE SIGNS LIST

1 single crystal silicon substrate
2 mask layer
3 opening pattern
4 through hole
5 hole
6 mask layer
10A, 10B nozzle plate
11 nozzle tip ejection port
12 nozzle tapered portion
13 straight communication passage
14 nozzle straight portion
21 protective film
22 protective film

1. A method for manufacturing a nozzle plate for a fluid ejection head through following steps 1 to 5, a nozzle plate having at least a nozzle tapered portion and a straight communication passage in a nozzle hole, the nozzle plate manufacturing method comprising:
step 1: a step of preparing a single crystal silicon substrate whose surface has a crystal orientation of a plane;
step 2: a step of uniformly forming a mask layer on the surface of the single crystal silicon substrate;
step 3: a step of forming an opening pattern in the mask layer;
step 4: a step of forming a through hole by penetrating the single crystal silicon substrate located below the opening pattern from the surface by dry etching; and
step 5: a step of forming a nozzle tapered portion and a straight communication passage continuous with the nozzle tapered portion by enlarging the through hole by anisotropic wet etching on the single crystal silicon substrate.

2. The nozzle plate manufacturing method according to claim 1,
wherein following steps 6 and 7 are performed between steps 3 and 4,
step 6: a step of forming a hole by deep-etching the single crystal silicon substrate located below the opening pattern from the surface by dry etching, and
step 7: a step of forming a mask layer on a side wall of the hole.

3 The nozzle plate manufacturing method according to claim 1 or 2,
wherein a step of forming a protective film covering a surface including an inside of the nozzle tapered portion and an inside of the straight communication passage is performed after step 5.

4. A nozzle plate for a fluid ejection head, comprising:
a straight communication passage formed by four planes continuous in a direction in which a diameter of a nozzle tapered portion, which is formed by four planes of single crystal silicon, increases.

5. A fluid ejection head, comprising:
the nozzle plate according to claim 4.
